(19) United States
(12) Patent Application Publication
(10) Pub. No.: US 2024/0427836 A1
(43) Pub. Date: Dec. 26, 2024

(54) DATA PROCESSING

(71) Applicant: Alipay (Hangzhou) Information Technology Co., Ltd., Hangzhou (CN)

(72) Inventors: Tianyi Li, Hangzhou (CN); Wuqiong Pan, Hangzhou (CN); Tingting Li, Hangzhou (CN); Tao Wei, Hangzhou (CN); Zhongtian Qian, Hangzhou (CN)

(73) Assignee: Alipay (Hangzhou) Information Technology Co., Ltd., Hangzhou (CN)

(21) Appl. No.: 18/824,400

(22) Filed: Sep. 4, 2024

Related U.S. Application Data
(63) Continuation of application No. PCT/CN2023/071291, filed on Jan. 9, 2023.

(30) Foreign Application Priority Data
Mar. 4, 2022 (CN) CN202210213272.4

(51) Int. Cl. G06F 17/11

(52) U.S. Cl. CPC G06F 17/11

(57) ABSTRACT

In an example data processing method, a data processing task is received, which includes a to-be-processed non-polynomial function and to-be-processed data corresponding to an independent variable of the non-polynomial function. A first linear transformation is performed on the to-be-processed data, so that an independent variable value corresponding to data obtained after the first linear transformation falls within a fitting domain of definition. The fitting domain of definition is an interval selected from a domain of definition of the independent variable of the non-polynomial function. A fitting polynomial function value is obtained based on the data obtained after the first linear transformation. The fitting polynomial is obtained by performing Chebyshev series fitting on the non-polynomial function in the fitting domain of definition. A second linear transformation is performed on the fitting polynomial function value based on the first linear transformation, and a value of the non-polynomial function is obtained.

### CROSS-REFERENCE TO RELATED APPLICATIONS

This application is a continuation of PCT Application No. PCT/CN2023/071291, filed on Jan. 9, 2023, which claims priority to Chinese Patent Application No. CN202210213272.4, filed on Mar. 4, 2022, and each application is hereby incorporated by reference in its entirety.

### TECHNICAL FIELD

One or more embodiments of this specification are associated with the field of computer technologies, and in particular, to data processing methods and apparatuses.

### BACKGROUND

Non-polynomial mathematical functions such as log (logarithmic function), sqrt (square root function), sin (sine function), and cos (cosine function) are usually used in machine learning and cryptographic data analysis. In mathematics, a polynomial function is a function obtained by performing a limited quantity of multiplication and addition operations on a constant and an independent variable. It is easy to understand that the non-polynomial function does not simply include multiplication and addition. In many application systems, an algorithm only supports addition and multiplication. Therefore, a method for processing a non-polynomial function with high precision is urgently needed.

### SUMMARY

One or more embodiments of this specification describe data processing methods, to implement processing of a non-polynomial function with high precision.

According to a first aspect, a data processing method is provided, including: receiving a data processing task, where the data processing task includes a to-be-processed non-polynomial function and to-be-processed data corresponding to an independent variable of the non-polynomial function; performing a first linear transformation on the to-be-processed data, so that an independent variable value corresponding to data obtained after the first linear transformation falls within a fitting domain of definition, where the fitting domain of definition is an interval selected from a domain of definition of the independent variable of the non-polynomial function; obtaining a corresponding fitting polynomial function value based on the data obtained after the first linear transformation, where the fitting polynomial is obtained by performing Chebyshev series fitting on the non-polynomial function in the fitting domain of definition; and performing a second linear transformation on the fitting polynomial function value based on the first linear transformation, and then obtaining a value of the non-polynomial function.

According to an implementable manner of one or more embodiments of this application, the method further includes: predetermining the domain of definition of the independent variable of the non-polynomial function, selecting an interval from the domain of definition as the fitting domain of definition, and performing Chebyshev series fitting on the non-polynomial in the fitting domain of definition, to obtain the fitting polynomial function.

According to an implementable manner of one or more embodiments of this application, the determining the domain of definition of the independent variable of the non-polynomial function includes: determining the domain of definition of the independent variable of the polynomial function based on a meaning of the independent variable in an application system, a fixed-point number range used in the application system, and a type of the to-be-processed polynomial function.

According to an implementable manner of one or more embodiments of this application, the selecting an interval from the domain of definition as the fitting domain of definition includes: if the non-polynomial function is an aperiodic function, selecting an interval from a plurality of segment intervals of the domain of definition as the fitting domain of definition, to ensure a precision requirement of an application system on a non-polynomial function value, and prevent multiplication from overflowing out of a fixed-point number range used in the application system; or if the non-polynomial function is a periodic function, selecting an interval including at least one period from the domain of definition as the fitting domain of definition, to ensure a precision requirement of an application system on a non-polynomial function value, and prevent multiplication from overflowing out of a fixed-point number range used in the application system.

According to an implementable manner of one or more embodiments of this application, the non-polynomial function is an aperiodic function, the first linear transformation is performing multiplication by m1, the second linear transformation includes performing multiplication by n1 and/or performing addition by n2, a relationship among m1, n1, and n2 is determined based on a type of the non-polynomial function, and m1, n1, and n2 are real numbers.

According to an implementable manner of one or more embodiments of this application, the method further includes: if the non-polynomial function is a periodic function, the first linear transformation is adding or reducing at least one period value; and after the corresponding fitting polynomial function value is obtained, obtaining the value of the non-polynomial function based on the fitting polynomial function value.

According to an implementable manner in one or more embodiments of this application, before the performing a first linear transformation on the to-be-processed data, the method further includes: determining whether an independent variable value corresponding to the to-be-processed data has been in the fitting domain of definition; and if yes, directly obtaining the corresponding fitting polynomial function value based on the to-be-processed data, to obtain the value of the non-polynomial function; otherwise, continuing to perform the step of performing a first linear transformation on the to-be-processed data.

According to an implementable manner of the embodiments of this application, the method is applied to a secure multi-party computation MPC application scenario, and is performed by an MPC computation party; the to-be-processed data come from a data component sent by a data provider to the MPC computation party, and the data component is one of components obtained by the data provider by randomly splitting the data; and the to-be-processed non-polynomial function is a non-polynomial function included in an MPC algorithm.

According to a second aspect, a data processing apparatus is provided, including: a task receiving unit, configured to receive a data processing task, where the data processing task includes a to-be-processed non-polynomial function and to-be-processed data corresponding to an independent variable of the non-polynomial function; a first transformation unit, configured to perform a first linear transformation on the to-be-processed data, so that an independent variable value corresponding to data obtained after the first linear transformation falls within a fitting domain of definition, where the fitting domain of definition is an interval selected from a domain of definition of the independent variable of the non-polynomial function; a function computing unit, configured to obtain a corresponding fitting polynomial function value based on the data obtained after the first linear transformation, where the fitting polynomial is obtained by performing Chebyshev series fitting on the non-polynomial function in the fitting domain of definition; a second transformation unit, configured to perform a second linear transformation on the fitting polynomial function value based on the first linear transformation; and a function value obtaining unit, configured to obtain a value of the non-polynomial function based on a result of the second linear transformation.

According to a third aspect, a computing device is provided, including a memory and a processor. The memory stores executable code, and when executing the executable code, the processor implements the method in the first aspect.

According to the method and the apparatus provided in the embodiments of the specification, the domain of definition is narrowed, and a corresponding linear transformation is performed on a function value obtained after Chebyshev series fitting, to obtain the value of the non-polynomial function. Narrowing of the domain of definition reduces a probability of integer overflow, and ensures a quantity of decimal places, to improve computing precision of the non-polynomial function.

### BRIEF DESCRIPTION OF DRAWINGS

To describe the technical solutions in the embodiments of this application or in the existing technology more clearly, the following briefly describes the accompanying drawings needed for describing the embodiments or the existing technology. Clearly, the accompanying drawings in the following description show some embodiments of this application, and a person of ordinary skill in the art can still derive other drawings from these accompanying drawings without creative efforts.

FIG. 1 is a flowchart illustrating a data processing method, according to an embodiment;

FIG. 2 is a schematic diagram illustrating a TECC application scenario, according to one or more embodiments of this application;

FIG. 3 is a flowchart illustrating a data processing method, according to another embodiment; and

FIG. 4 is a schematic block diagram illustrating a data processing apparatus, according to an embodiment.

### DESCRIPTION OF EMBODIMENTS

The terms used in the embodiments of this application are merely used to describe specific embodiments, and are not intended to limit this application. The terms “a”, “said”, and “the” of singular forms used in the embodiments of this application and the appended claims are also intended to include plural forms, unless otherwise specified in the context clearly.

It should be understood that the term “and/or” used in this specification merely describes an association relationship between associated objects and indicates that three relationships can exist. For example, A and/or B can indicate the following three cases: Only A exists, both A and B exist, and only B exists. In addition, the character “/” in this specification usually indicates an “or” relationship between the associated objects.

Depending on the context, for example, the word “if” used here can be interpreted as “while”, “when”, “in response to determining”, or “in response to detecting”. Similarly, depending on the context, the phrase “if determining . . . ” or “if detecting (the condition or event stated)” can be explained as “when determining . . . ”, “in response to determining . . . ”, “when detecting (the condition or event stated)”, or “in response to detecting (the condition or event stated)”.

Solutions provided in this specification are described below with reference to the accompanying drawings.

To transform a non-polynomial function to a polynomial function, in most current solutions, Chebyshev series fitting is performed on a domain of definition of an independent variable of the polynomial function, to obtain the polynomial function.

However, in most application scenarios, there is a certain precision requirement, and a fixed-point number is used in an algorithm such as secure multi-party computation (MPC). The fixed-point number is usually a fixed-point decimal. Most of numeric data processed by a computer include decimals, and a decimal point is usually implied at a fixed location, which becomes a fixed-point representation, and is briefly referred to as a fixed-point number. Because the fixed-point number has a limited representation range, for example, in a 64-bit fixed-point number, and 16 bits are used for decimal places, and can at most represent a number of five decimal places after the decimal point. To prevent multiplication from integer overflowing, a maximum value is usually 2¹⁶. In other words, 32 bits in a 64-bit integer are used. When Chebyshev series fitting is actually performed, the following problems may occur: (1) If the domain of definition of the independent variable is very large, and an input independent variable is very close to a boundary of the domain of definition, a difference between a real value and a value obtained through fitting by using a Chebyshev technology is very large, and even a computing error is caused. For example, an absolute value of a computing result of a triangular function is greater than 1.

(2) If a value of the independent variable is very large, integer overflow may occur in an intermediate computing step when a Chebyshev series is computed, so that a result of Chebyshev series fitting is incorrect.

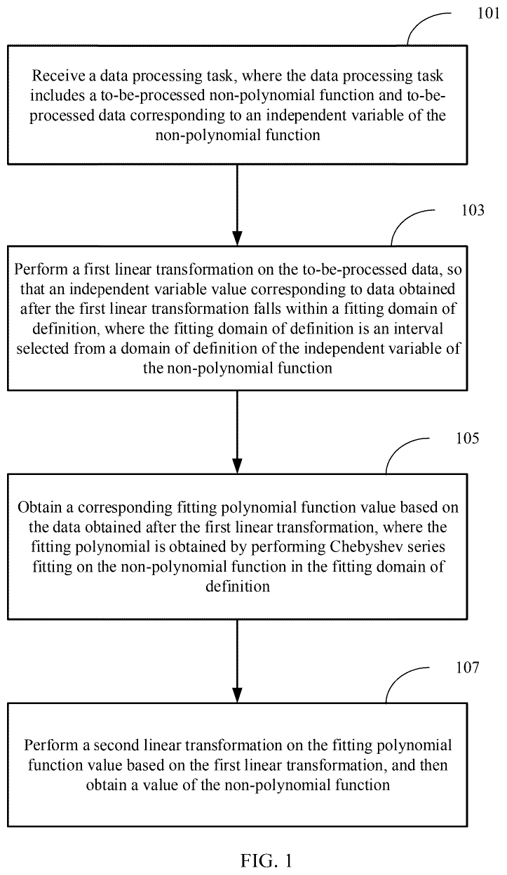

It is found through analysis that, when a highest degree of the Chebyshev series is fixed, a smaller domain of definition of the independent variable leads to better Chebyshev fitting effect. Therefore, one or more embodiments of this application provide a data processing method shown in FIG. 1.

FIG. 1 is a flowchart illustrating a data processing method, according to an embodiment. It can be understood that the method can be performed by any apparatus, device, platform, or device cluster that has computing and processing capabilities. As shown in FIG. 1, the method includes: Step 101: Receive a data processing task, where the data processing task includes a to-be-processed non-polynomial function and to-be-processed data corresponding to an independent variable of the non-polynomial function.

Step 103: Perform a first linear transformation on the to-be-processed data, so that an independent variable value corresponding to data obtained after the first linear transformation falls within a fitting domain of definition, where the fitting domain of definition is an interval selected from a domain of definition of the independent variable of the non-polynomial function.

Step 105: Obtain a corresponding fitting polynomial function value based on the data obtained after the first linear transformation, where the fitting polynomial is obtained by performing Chebyshev series fitting on the non-polynomial function in the fitting domain of definition.

Step 107: Perform a second linear transformation on the fitting polynomial function value based on the first linear transformation, and then obtain a value of the non-polynomial function.

It can be seen that, in this application, the domain of definition is narrowed, and a corresponding linear transformation is performed on a function value obtained after Chebyshev series fitting, to obtain the value of the non-polynomial function. Narrowing of the domain of definition reduces a probability of integer overflow, and ensures a quantity of decimal places, to improve computing precision of the non-polynomial function.

The above-mentioned method procedure provided in one or more embodiments of this application can be applied to a plurality of application scenarios, for example, the machine learning field or the cryptographic data analysis field. The cryptographic data analysis field is used as an example. Trusted-environment-based cryptographic computing (TECC) is based on an MPC algorithm, is a secure and efficient cryptographic computing method, and can be that a plurality of participants compute a common result without disclosing data of any party. Trusted-environment-based cryptographic computing combines two technologies of system security and cryptography, to better balance security and performance than using only one technology.

FIG. 2 is a schematic diagram illustrating a TECC application scenario, according to one or more embodiments of this application. As shown in FIG. 2, data to be provided by a data provider to TECC are randomly split into a plurality of data components. For example, data u are split into u1, u2, and u3. The data provider establishes a secure channel with each of a plurality of trusted execution environments (TEE), and provides the components to each of different TEEs. For example, a data provider 1 provides u1 and u2 to a TEE A, provides u2 and u3 to a TEE B, and provides u3 and u1 to a TEE C. After obtaining a data component, each TEE performs data processing based on the MPC algorithm.

It can be seen that, in TECC, the data provider can ensure, based on a TEE technology, that the data of the data provider only exist in the TEE, and each TEE directly contacts the data component. Even if an attacker breaks through a TEE and steals or modifies it for a long time period, valid information cannot be obtained.

In this application scenario, when the TEE processes the data component, some non-polynomial functions are used in related processing such as machine learning and cryptographic data analysis in privacy-preserving computing. However, the MPC algorithm only supports polynomial processing such as addition and multiplication. Therefore, the data processing method provided in one or more embodiments of this application can be used for processing. It should be noted here that the technical solution provided in one or more embodiments of this application is not limited to the TECC application scenario, but is applicable to any secure multi-party computation scenario. Therefore, the technical solution is not limited to being executed by the TEE, but is applicable to any MPC computation party. FIG. 2 shows only an example in which one application scenario is TECC. For ease of understanding, the TECC application scenario is used as an example for description in a subsequent embodiment. However, there can be an extension to another application scenario within the same spirit and principle.

The following describes execution manners of the steps shown in FIG. 1.

The to-be-processed non-polynomial function and the to-be-processed data used in step 101 are briefly described.

When the non-polynomial function needs to be used in a data processing process, the non-polynomial function can be used as the to-be-processed non-polynomial function. A specific non-polynomial function that needs to be used in the algorithm is usually predetermined.

The to-be-processed data correspond to the independent variable of the non-polynomial function. In some cases, the to-be-processed data are an independent variable value of the non-polynomial function. In some other cases, the to-be-processed data are a component of an independent variable value of the non-polynomial function. For example, in the application scenario shown in FIG. 2, to-be-processed data used when each TEE executes the MPC algorithm are a data component obtained by each TEE, and the independent variable value of the non-polynomial function originally needs to be original data existing before a data transmitter performs data splitting. However, based on the data component, each TEE cannot learn of a specific value of the original data, but can learn of a value range of the original data.

In addition to the application scenario shown in FIG. 2, other to-be-processed data can be used. This application sets no limitation thereto.

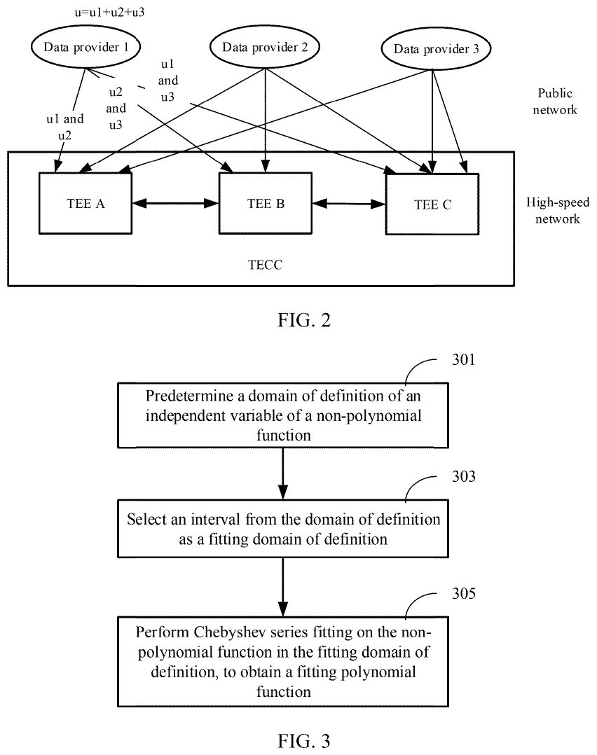

Because the fitting domain of definition and the fitting polynomial function are used in a procedure shown in FIG. 1, in some implementations, to improve data processing efficiency, the fitting domain of definition and the fitting polynomial function can be pre-obtained for each polynomial function, so that when the to-be-processed data are obtained, the to-be-processed data can be directly obtained based on the fitting domain of definition and the fitting polynomial function that are pre-obtained. Before step 101 in the procedure shown in FIG. 1, the following steps can be first performed as shown in FIG. 3: Step 301: Predetermine the domain of definition of the independent variable of the non-polynomial function.

The domain of definition is a value range of an independent variable of a function, and is a value range of the independent variable of the non-polynomial function in one or more embodiments of this application. The domain of definition is mainly determined based on the following factors: A factor 1 is a type of the to-be-processed non-polynomial function. In other words, for a natural domain of definition of a function, a value range of an independent variable that makes the function meaningful is referred to as the natural domain of definition. For example, for the following non-polynomial function, to make the function meaningful, the independent variable x needs to be a real number greater than or equal to 0.

$$f ( x ) = sqrt ( x ) = \sqrt{x} .$$

A factor 2 is a meaning of the independent variable in an application system. To be specific, usually, in different application scenarios, the independent variable has a specific meaning, and the value range of the independent variable needs to match the meaning of the independent variable. For example, in some application scenarios, the data component sent by the data provider is a data component of a data feature, the data feature includes a page access frequency, etc., and the page access frequency cannot be a negative value, and therefore, is usually a real number greater than or equal to 0.

A factor 3 is a fixed-point number range used in the application system. Limited by the fixed-point number range, a value of the independent variable cannot exceed an expression capability of a fixed-point number range of the independent variable.

The domain of definition of the independent variable of the non-polynomial function is mainly determined based on the three factors. Usually, the domain of definition is predetermined and recorded in the application system. In this step, pre-recorded content is directly obtained.

Step 303: Select an interval from the domain of definition as the fitting domain of definition.

As mentioned above, usually, when a highest degree of a Chebyshev series is fixed, a smaller domain of definition of the independent variable leads to better Chebyshev fitting effect. Therefore, to improve fitting effect, the domain of definition is narrowed, and an interval is selected from the domain of definition as the fitting domain of definition.

Usually, the application system has a certain precision requirement on data processing. The precision requirement needs to be ensured by using a decimal place of a fixed-point number. In addition, it also needs to be ensured that integer overflow cannot occur when multiplication occurs in the domain of definition. This requires a proper fitting domain of definition.

In an implementable manner, if the non-polynomial function is an aperiodic function, segment processing can be performed on the domain of definition of the independent variable. An interval is selected from a plurality of segment intervals as the fitting domain of definition, to ensure a precision requirement of the application system on a polynomial function value, and prevent multiplication from overflowing out of the fixed-point number range used in the application system.

A non-polynomial function sqrt(x) is as an example. If a domain of definition of x determined in step 301 is [2⁻¹⁶,2¹⁶], and the domain of definition can be divided into four segments [2¹⁶,2⁻⁸ ], [2⁻⁸,2⁰], [2⁰,2⁸] and [2⁸,2¹⁶]. In step 302, one segment [2⁸,2¹⁶] is selected as the fitting domain of definition in consideration of the precision requirement of the application system and prevention of multiplication from overflowing.

In another implementable manner, if the non-polynomial function is a periodic function, an interval including at least one period can be selected from the domain of definition as the fitting domain of definition, to ensure a precision requirement of the application system on a polynomial function value, and prevent multiplication from overflowing out of the fixed-point number range used in the application system.

A non-polynomial function sin(x) is used as an example, and is a periodic function whose period is 2 π. Therefore, one or several periods can be extracted from the domain of definition as the fitting domain of definition. For example, [−3 π, 7 π] is extracted as the fitting domain of definition.

In addition to the functions sqrt(x) and sin(x), similar processing is performed on another non-polynomial function. In addition, in addition to the above-mentioned example interval selection manner, a smaller or larger interval can be selected. However, usually, a smaller interval corresponding to the fitting domain of definition leads to higher computing precision and higher computing overheads. Therefore, a balance between computing precision and computing overheads needs to be achieved. The interval can be selected based on experience, experiment, etc.

Step 305: Perform Chebyshev series fitting on the non-polynomial function in the fitting domain of definition, to obtain the fitting polynomial function.

Chebyshev series fitting is an existing fitting manner. A formula of performing Chebyshev series fitting on the non-polynomial function ƒ(x) in an interval [−1, 1] is as follows:

$$f ( x ) = {\sum }_{n = 0}^{∞} {c}_{n} {T}_{n} ( x ) \qquad ( 1 )$$

Here, cₙ is a coefficient of the Chebyshev series, and is computed based on the following formula:

$${c}_{0} = \frac{1}{π} {\int }_{- 1}^{1} \frac{f ( x )}{\sqrt{1 - {x}^{2}}} dx = \frac{1}{π} {\int }_{0}^{π} f ( cos θ ) d θ \qquad ( 2 )$$

$${c}_{n} = \frac{1}{π} {\int }_{- 1}^{1} \frac{{T}_{n} ( x ) f ( x )}{\sqrt{1 - {x}^{2}}} dx = \frac{2}{π} {\int }_{0}^{π} f ( cos θ ) cos n θ d θ \qquad ( 3 )$$

The Formula (3) is a computing formula existing when n is not 0.

Tₙ(x) in Formula (1) is computed in a recursive manner, and a recursive formula is as follows:

$${T}_{n + 1} ( x ) = 2 x {T}_{n} ( x ) - {T}_{n - 1} ( x ) \qquad ( 4 )$$

Examples are as follows:

$${T}_{0} ( x ) = 1$$

$${T}_{1} ( x ) = x$$

$${T}_{2} ( x ) = 2 {x}^{2} - 1$$

$${T}_{3} ( x ) = 4 {x}^{3} - 3 x$$

$${T}_{4} ( x ) = 8 {x}^{4} - 8 {x}^{2} + 1$$

$${T}_{5} ( x ) = 16 {x}^{5} - 20 {x}^{3} + 5 x$$

Similar computing is performed, until a maximum degree, namely, a maximum value of n is reached.

A larger degree leads to higher computing precision, and corresponds to higher computing overheads. A balance between computing precision and computing overheads needs to be achieved. An empirical value or an experimental value can be used.

In one or more embodiments of this application, the fitting domain of definition is mapped onto the interval [−1, 1], and the coefficient of the Chebyshev series is computed for the non-polynomial function, to perform Chebyshev fitting. If the fitting domain of definition is [a, b], a mapping function is used:

$$g ( x ) = \frac{2 x - b - a}{b - a} .$$

The fitting domain of definition is mapped onto the interval [−1, 1]. To be specific,

$$\frac{2 x - b - a}{b - a}$$

is used as x in Formula (1) for replacement, to perform Chebyshev series fitting. Because Chebyshev series fitting is an existing technology, details are omitted here.

The fitting polynomial function obtained by fitting the non-polynomial function in this step can be pre-computed and stored, for example, hard-coded into an MPC program, and can be directly invoked in a subsequent step, namely, step 105.

Step 103 of “performing a first linear transformation on the to-be-processed data, so that an independent variable value corresponding to data obtained after the first linear transformation falls within a fitting domain of definition” is described in detail below with reference to the embodiments.

If the to-be-processed data are the independent variable value of the to-be-processed non-polynomial function, the first linear transformation is performed on the to-be-processed data, so that the data obtained after transformation fall within the fitting domain of definition.

If the to-be-processed data are a data component of the independent variable value of the non-polynomial function, a value range of the independent variable value can be inferred based on the data component, and then a specific first linear transformation that can enable the value range of the independent variable value to fall within the fitting domain of definition is determined based on the value range and the fitting domain of definition.

In some implementations, performing the first linear transformation on the to-be-processed data can be performing multiplication by one multiple, for example, performing multiplication by m1. Here, m1 can be a real number, and can be a number whose absolute value is greater than 1, or can be a number whose absolute value is less than 1, or can be a positive number, or can be a negative number. A specific value is determined based on the independent variable value corresponding to the to-be-processed data and the fitting domain of definition, so that a corresponding independent variable value obtained after the first linear transformation falls within the fitting domain of definition.

For example, for the non-polynomial function sqrt(x), the fitting domain of definition is [2⁸,2¹⁶]. If the independent variable value is x<2⁻⁸, a value obtained by multiplexing x by 2¹⁶ can fall within the fitting domain of definition. If 2⁻⁸≤x<2⁰, a value obtained by multiplexing x by 2⁸ can fall within the fitting domain of definition. If x>2⁸, a value obtained by multiplexing x by

$$\frac{1}{{2}^{8}}$$

can fall within the fitting domain of definition.

In some other implementations, for a periodic non-polynomial function, an independent variable value can be increased or decreased by at least one period value, so that the independent variable value falls within the fitting domain of definition.

For example, for the non-polynomial function sin(x), if the fitting domain of definition is [−3π,7π], x can be increased or decreased by several 2π, so that the independent variable value falls within the fitting domain of definition.

Step 107 of “performing a second linear transformation on the fitting polynomial function value, to obtain a polynomial function value corresponding to an input independent variable value” is described in detail below with reference to the embodiments.

There can be two cases of this step: Case 1: If the non-polynomial function is a periodic function, the second linear transformation performed on the independent variable in step 105 is adding or reducing at least one period value. In this case, the fitting polynomial function value can be kept unchanged in this step. In other words, the fitting polynomial function value is used to obtain the value of the non-polynomial function.

The above-mentioned example of the non-polynomial function sin(x) is still used. If the fitting domain of definition is [−3π,7π], a value of the independent variable x can be increased or decreased by several 2π, so that a value falls within the fitting domain of definition. A triangular function has the following period feature, that is, sin(x+2lπ)=sin(x) Here, l is an integer. Therefore, after Chebyshev fitting is performed on a value obtained by adding or reducing the independent variable by an integral quantity of 2π, an obtained fitting polynomial function value is a non-polynomial function value corresponding to the value of the independent variable x.

Case 2: If the non-polynomial function is an aperiodic function, the input value of the independent variable x can be multiplied by m1. The used second linear transformation is performing multiplication by n1 and/or performing addition by n2. A relationship among m1, n1, and n2 is determined based on the type of the non-polynomial function. Here, m1, n1, and n2 are real numbers.

The above-mentioned example of the non-polynomial function sqrt(x) is still used, and the fitting domain of definition is [2⁸,2¹⁶].

If the input independent variable is x<2⁻⁸, a value obtained by multiplexing x by 2¹⁶ can fall within the fitting domain of definition. In other words, Chebyshev series fitting is performed based on x*2¹⁶ to obtain c(x*2¹⁶), and then the second linear transformation performed on c(x*2¹⁶) is performing multiplication by

$$\frac{1}{{2}^{8}} .$$

In this case, a polynomial is as follows:

$${sqrt ( x )}_{=} c ( x * {2}^{16} ) * \frac{1}{{2}^{8}} .$$

If the input independent variable is 2⁻⁸≤x<2⁰, a value obtained by multiplexing x by 2⁸ can fall within the fitting domain of definition, Chebyshev series fitting is performed based on x*2⁸, to obtain c(x*2⁸), and then the second linear transformation performed on c(x*2⁸) is performing multiplication by

$$\frac{1}{{2}^{4}} .$$

In this case, a polynomial is as follows:

$$sqrt ( x ) = c ( x * {2}^{8} ) * \frac{1}{{2}^{4}} .$$

If the input independent variable is 2⁸≤x<2¹⁶, a value of the independent variable x falls within the fitting domain of definition, and Chebyshev series fitting is performed on x, to obtain c(x). The second linear transformation does not need to be performed. In this case, a polynomial is as follows:

sqrt(x)=c(x)

If the input independent variable is x>2⁸, a value obtained by multiplexing x by

$$\frac{1}{{2}^{8}}$$

can fall within the fitting domain of definition, Chebyshev series fitting is performed based on

$$x * \frac{1}{{2}^{8}} ,$$

to obtain

$$c ( x * \frac{1}{{2}^{8}} ) ,$$

and then the second linear transformation performed on

$$c ( x * \frac{1}{{2}^{8}} )$$

is performing multiplication by 2⁴. In this case, a polynomial is as follows:

$$sqrt ( x ) = c ( x * \frac{1}{{2}^{8}} ) * {2}^{4} .$$

In this manner, Chebyshev series fitting can be performed on a small fitting domain of definition, to improve computing precision, and reduce integer overflow of multiplication, and then a final non-polynomial function value is obtained through linear transformation.

In a TECC scenario shown in FIG. 2, three parties, namely, a TEE A, a TEE B, and a TEE C that process data based on the MPC algorithm are in the same high-speed network, and usually, an intra-network bandwidth can reach 10 Gbps. Computing the Chebyshev series is actually computing a polynomial of a degree n. Therefore, n times of multiplication and n times of addition need to be performed. The TEE A, the TEE B, and the TEE C each obtain a data component. It is assumed that the non-polynomial function sqrt(x) needs to be computed, and sqrt(u1+u2+u3) actually needs to be computed. For example, a computing manner of the fitting polynomial function is as follows:

$$sqrt ( x ) = c ( x * {2}^{16} ) * \frac{1}{{2}^{8}} = c ( ( u 1 + u 2 + u 3 ) * {2}^{16} ) * \frac{1}{{2}^{8}} .$$

The Chebyshev series c((u1+u2+u3)*2¹⁶) relates to multiplication and addition of (u1+u2+u3) The TEE A, TEE B and TEE C do not need to communicate with each other during addition, provided that a summary is made after each performs computing. The TEE A, TEE B and TEE C need to communicate with each other during multiplication. However, all TEEs are located in the same high-speed network. A bandwidth can reach 10 Gbps, and imposes very small impact on computing efficiency. It is experimentally verified that it takes only a few seconds to compute a 64-bit Chebyshev series for tens of millions of times. Therefore, it is completely feasible to implement computing of a cryptographic mathematical function through high-degree Chebyshev series fitting.

Specific embodiments of this specification are described above. Other embodiments fall within the scope of the appended claims. In some cases, the actions or steps described in the claims can be performed in an order different from that in the embodiments, and the desired results can still be achieved. In addition, the process depicted in the accompanying drawings does not necessarily need a particular sequence or consecutive sequence to achieve the desired results. In some implementations, multi-tasking and concurrent processing are feasible or may be advantageous.

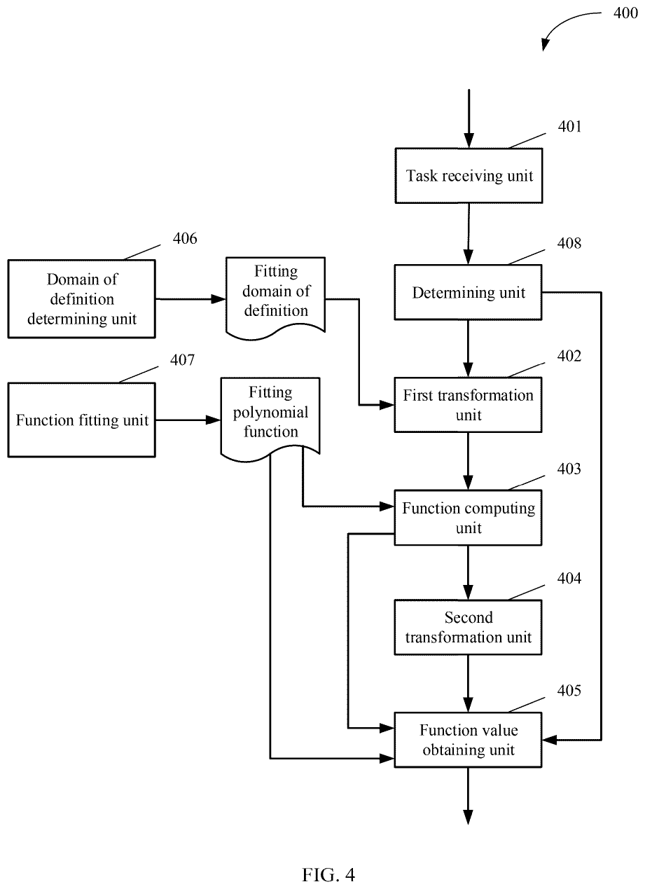

According to one or more embodiments of another aspect, a data processing apparatus is provided. FIG. 4 is a schematic block diagram illustrating a data processing apparatus, according to an embodiment. It can be understood that the apparatus can be implemented by any apparatus, device, platform, and device cluster that have computing and processing capabilities. As shown in FIG. 4, the apparatus 400 includes a task receiving unit 401, a first transformation unit 402, a function computing unit 403, a second transformation unit 404, and a function value obtaining unit 405, and can further include a domain of definition determining unit 406, a function fitting unit 407, and a determining unit 408. Main functions of constitutional units are as follows: The task receiving unit 401 is configured to receive a data processing task, where the data processing task includes a to-be-processed non-polynomial function and to-be-processed data corresponding to an independent variable of the non-polynomial function; the first transformation unit 402 is configured to perform a first linear transformation on the to-be-processed data, so that an independent variable value corresponding to data obtained after the first linear transformation falls within a fitting domain of definition, where the fitting domain of definition is an interval selected from a domain of definition of the independent variable of the non-polynomial function; the function computing unit 403 is configured to obtain a corresponding fitting polynomial function value based on the data obtained after the first linear transformation, where the fitting polynomial is obtained by performing Chebyshev series fitting on the non-polynomial function in the fitting domain of definition; the second transformation unit 404 is configured to perform a second linear transformation on the fitting polynomial function value based on the first linear transformation; and the function value obtaining unit 405 is configured to obtain a value of the non-polynomial function based on a result of transformation performed by the second transformation unit 404.

The domain of definition determining unit 406 is configured to: predetermine the domain of definition of the independent variable of the non-polynomial function, and select an interval from the domain of definition as the fitting domain of definition.

The function fitting unit 407 is configured to perform Chebyshev series fitting on the non-polynomial in the fitting domain of definition, to obtain the fitting polynomial function.

The fitting polynomial function that is of the non-polynomial and that is obtained by the function fitting unit 407 can be prestored, so that after the task receiving unit 104 receives the data processing task, the function computing unit 403 invokes the data processing task.

The domain of definition determining unit 406 can determine the domain of definition of the independent variable of the polynomial function based on a meaning of the independent variable in an application system, a fixed-point number range used in the application system, and a type of the to-be-processed polynomial function.

In an implementable manner, if the non-polynomial function is an aperiodic function, the domain of definition determining unit 405 can select an interval from a plurality of segment intervals of the domain of definition as the fitting domain of definition, to ensure a precision requirement of an application system on a non-polynomial function value, and prevent multiplication from overflowing out of a fixed-point number range used in the application system.

In another implementable manner, if the non-polynomial function is a periodic function, the domain of definition determining unit 406 can select an interval including at least one period from the domain of definition as the fitting domain of definition, to ensure a precision requirement of the application system on a non-polynomial function value, and prevent multiplication from overflowing out of the fixed-point number range used in the application system.

In an implementable manner, the non-polynomial function is an aperiodic function, the first linear transformation is performing multiplication by m1, the second linear transformation includes performing multiplication by n1 and/or performing addition by n2, a relationship among m1, n1, and n2 is determined based on a type of the non-polynomial function, and m1, n1, and n2 are real numbers.

If the non-polynomial function is a periodic function, the first linear transformation is adding or reducing at least one period value; and after the function computing unit 403 obtains the corresponding fitting polynomial function value, the function value obtaining unit 405 can directly obtain the value of the non-polynomial function based on the fitting polynomial function value.

In an implementable manner, the determining unit 408 can determine whether an independent variable value corresponding to the to-be-processed data has been in the fitting domain of definition; and if yes, the function value obtaining unit 405 directly obtains the corresponding fitting polynomial function value based on the to-be-processed data, to obtain the value of the non-polynomial function; otherwise, the first transformation unit 402 is triggered to perform processing of performing the first linear transformation on the to-be-processed data.

The apparatus can be applied to a secure multi-party computation application scenario. For example, the task receiving unit 401, the first transformation unit 402, the function computing unit 403, the second transformation unit 404, the function value obtaining unit 405, and the determining unit 408 are disposed in an MPC computation party. The to-be-processed data can come from a data component sent by a data provider to the MPC computation party. The to-be-processed non-polynomial function can be a non-polynomial function included in an MPC algorithm.

According to one or more embodiments of another aspect, a computer-readable storage medium is further provided. The computer-readable storage medium stores a computer program, and when the computer program is executed on a computer, the computer is enabled to perform the method described with reference to FIG. 1 or FIG. 3.

One or more embodiments of still another aspect further provide a computing device, including a memory and a processor. The memory stores executable code. When the processor executes the executable code, the method described with reference to FIG. 1 or FIG. 3 is implemented.

With development of time and technology, a computer-readable storage medium has a broader meaning. A propagation path of a computer program is not limited to a tangible medium, can be directly downloaded from a network, etc. Any combination of one or more computer-readable storage media can be used. The computer-readable storage medium can be, by way of example rather than limitation, an electrical, magnetic, optical, electromagnetic, infrared, or semiconductor system, apparatus, or device, or any combination thereof. More specific examples (a non-exhaustive list) of the computer-readable storage medium include the following: an electrical connection with one or more leads, a portable computer disk, a hard disk, a random access memory (RAM), a read-only memory (ROM), an erasable programmable read-only memory (an EPROM or a flash memory), an optical fiber, a portable compact disk read-only memory (CD-ROM), an optical storage component, a magnetic storage device, or any suitable combination thereof. In this specification, the computer-readable storage medium can be any tangible medium that includes or stores a program, and the program can be used by or in combination with an instruction execution system, apparatus, or component.

The processor can include one or more single-core processors or a multi-core processor. The processor can include any combination of a general-purpose processor or a dedicated processor (for example, an image processor, an application processor, or a baseband processor).

Embodiments of this specification are all described in a progressive manner, for same or similar parts in embodiments, mutual reference may be made to these embodiments, and each embodiment focuses on a difference from other embodiments. In particular, the apparatus embodiment is basically similar to the method embodiment, and therefore is described briefly. For related parts, references can be made to related descriptions in the method embodiment.

A person skilled in the art should be aware that, in the above-mentioned one or more examples, functions described in this application can be implemented by hardware, software, firmware, or any combination thereof. When being implemented by software, these functions can be stored in a computer-readable medium or transmitted as one or more instructions or codes in the computer-readable medium.

The specific implementations mentioned above provide further detailed explanations of the objectives, technical solutions, and beneficial effects of this application. It should be understood that the above-mentioned descriptions are merely specific implementations of this application and are not intended to limit the protection scope of this application. Any modifications, equivalent replacements, improvements, etc. made on the basis of the technical solutions of this application shall all fall within the protection scope of this application.

What is claimed is:

1. A method, comprising:
receiving, by a data processing apparatus, a data processing task, wherein the data processing task comprises a to-be-processed non-polynomial function and to-be-processed data corresponding to an independent variable of the non-polynomial function, wherein the to-be-processed data comprise fixed-point numbers;
performing, by the data processing apparatus, a first linear transformation on the to-be-processed data, so that an independent variable value corresponding to data obtained after the first linear transformation falls within a fitting domain of definition, wherein the fitting domain of definition is an interval selected from a domain of definition of the independent variable of the non-polynomial function;
obtaining, by the data processing apparatus, a fitting polynomial function value of a fitting polynomial based on the data obtained after the first linear transformation, wherein the fitting polynomial is obtained by performing Chebyshev series fitting on the non-polynomial function in the fitting domain of definition;
performing, by the data processing apparatus, a second linear transformation on the fitting polynomial function value based on the first linear transformation; and
obtaining a value of the non-polynomial function.

2. The method according to claim 1, wherein the method further comprises:
determining the domain of definition of the independent variable of the non-polynomial function;
selecting an interval from the domain of definition as the fitting domain of definition;
performing Chebyshev series fitting on the non-polynomial in the fitting domain of definition to obtain the fitting polynomial function; and
prestoring the fitting polynomial function of the non-polynomial function; and
after the data processing task is received, invoking the prestored fitting polynomial function of the non-polynomial function to perform the obtaining a fitting polynomial function value based on the data obtained after the first linear transformation.

3. The method according to claim 2, wherein the determining the domain of definition of the independent variable of the non-polynomial function comprises:
determining the domain of definition of the independent variable of the non-polynomial function based on a meaning of the independent variable in an application system, a fixed-point number range used in the application system, and a type of the to-be-processed polynomial function.

4. The method according to claim 2, wherein the selecting an interval from the domain of definition as the fitting domain of definition comprises:
if the non-polynomial function is an aperiodic function, selecting an interval from a plurality of segment intervals of the domain of definition as the fitting domain of definition, to ensure a precision requirement of an application system on a non-polynomial function value, and prevent multiplication from overflowing out of a fixed-point number range used in the application system; or
if the non-polynomial function is a periodic function, selecting an interval comprising at least one period from the domain of definition as the fitting domain of definition, to ensure a precision requirement of an application system on a non-polynomial function value, and prevent multiplication from overflowing out of a fixed-point number range used in the application system.

5. The method according to claim 1, wherein the non-polynomial function is an aperiodic function, the first linear transformation is performing multiplication by m1, the second linear transformation comprises one or more of performing multiplication by n1 or performing addition by n2, wherein a relationship among m1, n1, and n2 is determined based on a type of the non-polynomial function, and m1, n1, and n2 are real numbers.

6. The method according to claim 1, wherein the method further comprises:
wherein the non-polynomial function is a periodic function, the first linear transformation is adding or reducing at least one period value; and
after the fitting polynomial function value is obtained, obtaining the value of the non-polynomial function based on the fitting polynomial function value.

7. The method according to claim 1, wherein before the performing a first linear transformation on the to-be-processed data, the method further comprises:
determining whether an independent variable value corresponding to the to-be-processed data has been in the fitting domain of definition;
in response to determining that the independent variable value corresponding to the to-be-processed data has been in the fitting domain of definition, directly obtaining the fitting polynomial function value based on the to-be-processed data to obtain the value of the non-polynomial function; or
in response to determining that the independent variable value corresponding to the to-be-processed data has not been in the fitting domain of definition, continuing to perform the first linear transformation on the to-be-processed data.

8. The method according to claim 1, wherein:
the method is applied to a secure multi-party computation (MPC) application scenario, and is performed by an MPC computation party;
the to-be-processed data are from a data component sent by a data provider to the MPC computation party, and the data component is one of components obtained by the data provider by splitting data; and
the to-be-processed non-polynomial function is a non-polynomial function comprised in an MPC algorithm.

9. A non-transitory, computer-readable medium storing one or more instructions executable by a computer system to perform operations comprising:
receiving a data processing task, wherein the data processing task comprises a to-be-processed non-polynomial function and to-be-processed data corresponding to an independent variable of the non-polynomial function, wherein the to-be-processed data comprise fixed-point numbers;
performing a first linear transformation on the to-be-processed data, so that an independent variable value corresponding to data obtained after the first linear transformation falls within a fitting domain of definition, wherein the fitting domain of definition is an interval selected from a domain of definition of the independent variable of the non-polynomial function;
obtaining a fitting polynomial function value of a fitting polynomial based on the data obtained after the first linear transformation, wherein the fitting polynomial is obtained by performing Chebyshev series fitting on the non-polynomial function in the fitting domain of definition;
performing a second linear transformation on the fitting polynomial function value based on the first linear transformation; and
obtaining a value of the non-polynomial function.

10. The non-transitory, computer-readable medium according to claim 9, wherein the operations further comprise:
determining the domain of definition of the independent variable of the non-polynomial function;
selecting an interval from the domain of definition as the fitting domain of definition;
performing Chebyshev series fitting on the non-polynomial in the fitting domain of definition to obtain the fitting polynomial function; and
prestoring the fitting polynomial function of the non-polynomial function; and
after the data processing task is received, invoking the prestored fitting polynomial function of the non-polynomial function to perform the obtaining a fitting polynomial function value based on the data obtained after the first linear transformation.

11. The non-transitory, computer-readable medium according to claim 10, wherein the determining the domain of definition of the independent variable of the non-polynomial function comprises:
determining the domain of definition of the independent variable of the non-polynomial function based on a meaning of the independent variable in an application system, a fixed-point number range used in the application system, and a type of the to-be-processed polynomial function.

12. The non-transitory, computer-readable medium according to claim 9, wherein before the performing a first linear transformation on the to-be-processed data, the operations further comprise:
determining whether an independent variable value corresponding to the to-be-processed data has been in the fitting domain of definition;
in response to determining that the independent variable value corresponding to the to-be-processed data has been in the fitting domain of definition, directly obtaining the fitting polynomial function value based on the to-be-processed data to obtain the value of the non-polynomial function; or
in response to determining that the independent variable value corresponding to the to-be-processed data has not been in the fitting domain of definition, continuing to perform the first linear transformation on the to-be-processed data.

13. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a data processing task, wherein the data processing task comprises a to-be-processed non-polynomial function and to-be-processed data corresponding to an independent variable of the non-polynomial function, wherein the to-be-processed data comprise fixed-point numbers;
performing a first linear transformation on the to-be-processed data, so that an independent variable value corresponding to data obtained after the first linear transformation falls within a fitting domain of definition, wherein the fitting domain of definition is an interval selected from a domain of definition of the independent variable of the non-polynomial function;
obtaining a fitting polynomial function value of a fitting polynomial based on the data obtained after the first linear transformation, wherein the fitting polynomial is obtained by performing Chebyshev series fitting on the non-polynomial function in the fitting domain of definition;
performing a second linear transformation on the fitting polynomial function value based on the first linear transformation; and
obtaining a value of the non-polynomial function.

14. The computer-implemented system according to claim 13, wherein the operations further comprise:
determining the domain of definition of the independent variable of the non-polynomial function;
selecting an interval from the domain of definition as the fitting domain of definition;
performing Chebyshev series fitting on the non-polynomial in the fitting domain of definition to obtain the fitting polynomial function; and
prestoring the fitting polynomial function of the non-polynomial function; and
after the data processing task is received, invoking the prestored fitting polynomial function of the non-polynomial function to perform the obtaining a fitting polynomial function value based on the data obtained after the first linear transformation.

15. The computer-implemented system according to claim 14, wherein the determining the domain of definition of the independent variable of the non-polynomial function comprises:
determining the domain of definition of the independent variable of the non-polynomial function based on a meaning of the independent variable in an application system, a fixed-point number range used in the application system, and a type of the to-be-processed polynomial function.

16. The computer-implemented system according to claim 14, wherein the selecting an interval from the domain of definition as the fitting domain of definition comprises:
if the non-polynomial function is an aperiodic function, selecting an interval from a plurality of segment intervals of the domain of definition as the fitting domain of definition, to ensure a precision requirement of an application system on a non-polynomial function value, and prevent multiplication from overflowing out of a fixed-point number range used in the application system; or
if the non-polynomial function is a periodic function, selecting an interval comprising at least one period from the domain of definition as the fitting domain of definition, to ensure a precision requirement of an application system on a non-polynomial function value, and prevent multiplication from overflowing out of a fixed-point number range used in the application system.

17. The computer-implemented system according to claim 13, wherein the non-polynomial function is an aperiodic function, the first linear transformation is performing multiplication by m1, the second linear transformation comprises one or more of performing multiplication by n1 or performing addition by n2, wherein a relationship among m1, n1, and n2 is determined based on a type of the non-polynomial function, and m1, n1, and n2 are real numbers.

18. The computer-implemented system according to claim 13, wherein the operations further comprise:
wherein the non-polynomial function is a periodic function, the first linear transformation is adding or reducing at least one period value; and
after the fitting polynomial function value is obtained, obtaining the value of the non-polynomial function based on the fitting polynomial function value.

19. The computer-implemented system according to claim 13, wherein before the performing a first linear transformation on the to-be-processed data, the operations further comprise:
determining whether an independent variable value corresponding to the to-be-processed data has been in the fitting domain of definition;
in response to determining that the independent variable value corresponding to the to-be-processed data has been in the fitting domain of definition, directly obtaining the fitting polynomial function value based on the to-be-processed data to obtain the value of the non-polynomial function; or
in response to determining that the independent variable value corresponding to the to-be-processed data has not been in the fitting domain of definition, continuing to perform the first linear transformation on the to-be-processed data.

20. The computer-implemented system according to claim 13, wherein:
the operations are applied to a secure multi-party computation (MPC) application scenario, and are performed by an MPC computation party;
the to-be-processed data are from a data component sent by a data provider to the MPC computation party, and the data component is one of components obtained by the data provider by splitting data; and
the to-be-processed non-polynomial function is a non-polynomial function comprised in an MPC algorithm.
